(19) United States
(12) Patent Application Publication
(10) Pub. No.: US 2020/0098038 A1
(43) Pub. Date: Mar. 26, 2020

(54) VEHICLE RENTAL SYSTEM AND VEHICLE RENTAL METHOD

(71) Applicant: HONDA MOTOR CO., LTD., Tokyo (JP)

(72) Inventors: Hirotaka Uchitomi, Tokyo (JP); Kei Nakajima, Tokyo (JP); Kichinosuke Fukuhara, Wako-shi (JP)

(21) Appl. No.: 16/544,175

(22) Filed: Aug. 19, 2019

(30) Foreign Application Priority Data
Sep. 20, 2018 (JP) 2018-175633

(51) Int. Cl. G06Q 30/06; G07C 5/08; B60L 58/12; G07C 5/00

(52) U.S. Cl. CPC G06Q 30/0645; G07C 5/008; B60L 58/12; G07C 5/0841

(57) ABSTRACT

A vehicle condition recognition module recognizes conditions of a plurality of rental candidate vehicles. An expected utilization mode recognition module recognizes an expected utilization mode that is a utilization mode of a rental vehicle that a user expects. A rental vehicle selection module selects one of rental candidate vehicles that can be used according to the expected utilization mode based on the conditions of the plurality of rental candidate vehicles recognized by the vehicle condition recognition module as a rental vehicle for the user.

### INCORPORATION BY REFERENCE

The present application claims priority under 35 U.S.C. § 119 to Japanese Patent Application No.2018-175633 filed on Sep. 20, 2018. The content of the application is incorporated herein by reference in its entirety.

### BACKGROUND OF THE INVENTION

### Field of the Invention

The present invention relates to a vehicle rental system and a vehicle rental method.

### Description of Related Art

Conventionally, there has been proposed an information providing system for providing a user who desires to rent an electric vehicle with information on the state of charge of a battery and a permissible running mileage of a rentable electric vehicles (for example, refer to Japanese Patent Laid-Open No. 2016-31730).

### SUMMARY OF THE INVENTION

### Technical Problem

According to the information providing system, a user can select a rental vehicle that is suitable for a planned running mileage of the user by confirming the state of charge of a battery and a permissible running mileage of the rental vehicle. However, there is now coming up a wide variety of utilization modes of rental vehicles by users, and the consumption of energy of a battery of a rental vehicle varies according to utilization modes of users while the vehicle is running or is stopped. Due to this, it is desired that users can select a rental vehicle by taking also into consideration electric power that is used for other applications than driving the vehicle.

The present invention has been made in view of these situations, and an object of the present invention is to provide a vehicle rental system and a vehicle rental method that enable a user to select a rental vehicle that matches his or her utilization mode.

### Solution to Problem

With a view to achieving the object, according to a first aspect of the present invention, there is raised a vehicle rental system including a vehicle condition recognition module configured to recognize conditions of a plurality of rental candidate vehicles, an expected utilization mode recognition module configured to recognize an expected utilization mode which is a utilization mode for a rental vehicle that a user expects, and a rental vehicle selection module configured to select one of the rental candidate vehicles that can be used according to the expected utilization mode based on the conditions of the plurality of rental candidate vehicles that are recognized by the vehicle condition recognition module as a rental vehicle for the user.

In the vehicle rental system described above, the expected utilization mode may include a mode in which the rental vehicle is used without being moved.

In the vehicle rental system described above, a configuration may be adopted in which the vehicle rental system includes an equipment specification recognition module configured to recognize equipment specifications of the plurality of rental candidate vehicles, the expected utilization mode includes a utilization of equipment of the rental vehicle by the user, and the rental vehicle selection module selects, as the rental vehicle for the user, one of the rental candidate vehicles that can be used according to the expected utilization mode based on the conditions of the plurality of rental candidate vehicles that are recognized by the vehicle condition recognition module and the equipment specifications of the plurality of rental candidate vehicles that are recognized by the equipment specification recognition module.

In the vehicle rental system described above, a configuration may be adopted in which the plurality of rental candidate vehicles are electrically driven vehicles, the vehicle condition recognition module recognizes a state of charge of a battery equipped on each of the plurality of rental candidate vehicles as the conditions of the plurality of rental candidate vehicles, and the rental vehicle selection module selects, as the rental vehicle for the user, one of the rental candidate vehicles including a battery whose state of charge is at a level where the rental candidate vehicle can be used according to the expected utilization mode based on a state of charge of a battery equipped on each of the plurality of rental candidate vehicles that is recognized by the vehicle condition recognition module.

In the vehicle rental system described above, a configuration may be adopted in which the vehicle rental system includes a parking space utilization schedule recognition module configured to recognize utilization schedules of parking spaces where the plurality of rental candidate vehicles are parked waiting to be rented, and the rental vehicle selection module selects for preference, as the rental vehicle for the user, one of the rental candidate vehicles that does not have to be moved from a parking space where the rental candidate vehicle is parked waiting to be rented based on a result of a recognition by the parking space utilization schedule recognition module.

In the vehicle rental system described above, a configuration may be adopted in which the vehicle rental system includes an in-compartment condition recognition module configured to recognize an in-compartment condition of the rental candidate vehicle, and the rental vehicle selection module makes selections for the rental vehicle for the user by excluding the rental candidate vehicles whose in-compartment conditions recognized by the in-compartment condition recognition module do not reach a predetermined well-conditioned level.

With a view to achieving the object described above, according to a second aspect of the present invention, there is raised a vehicle rental method including a vehicle condition recognition step of recognizing conditions of a plurality of rental candidate vehicles, an expected utilization mode recognition step of recognizing an expected utilization mode which is a utilization mode for a rental vehicle that a user expects, and a rental vehicle selection step of selecting one of the rental vehicles that is ready for use according to the expected utilization mode based on the conditions of the plurality of rental candidate vehicles that are recognized by the vehicle condition recognition step as a rental vehicle for the user.

### Advantageous Effect of the Invention

According to the vehicle rental system and the vehicle rental method, the conditions of the plurality of rental candidate vehicles are recognized by the vehicle condition recognition module or the vehicle condition recognition step. The expected utilization mode, which is the utilization mode of the rental vehicle that the user expects, is recognized by the expected utilization mode recognition module or the expected utilization mode recognition step. Then, the rental candidate vehicle that can be used according to the expected utilization mode is selected as the rental vehicle for the user based on the conditions of the plurality of rental candidate vehicles by the rental vehicle selection module or the rental vehicle selection step. As a result, the rental vehicle matching the utilization mode that the user expects can be selected.

### BRIEF DESCRIPTION OF THE DRAWINGS

FIG. 1 is a block diagram of a vehicle rental system;

FIG. 2 is an explanatory diagram of information on a rental candidate vehicle;

FIG. 3 is an explanatory diagram of information on an expected utilization mode;

FIG. 4 is a flow chart of a rental vehicle selection process; and

FIG. 5 is an explanatory diagram of a reservation receiving screen and a reservation completed screen.

### DETAILED DESCRIPTION OF THE PREFERRED EMBODIMENTS

### 1. Configuration of Vehicle Rental System

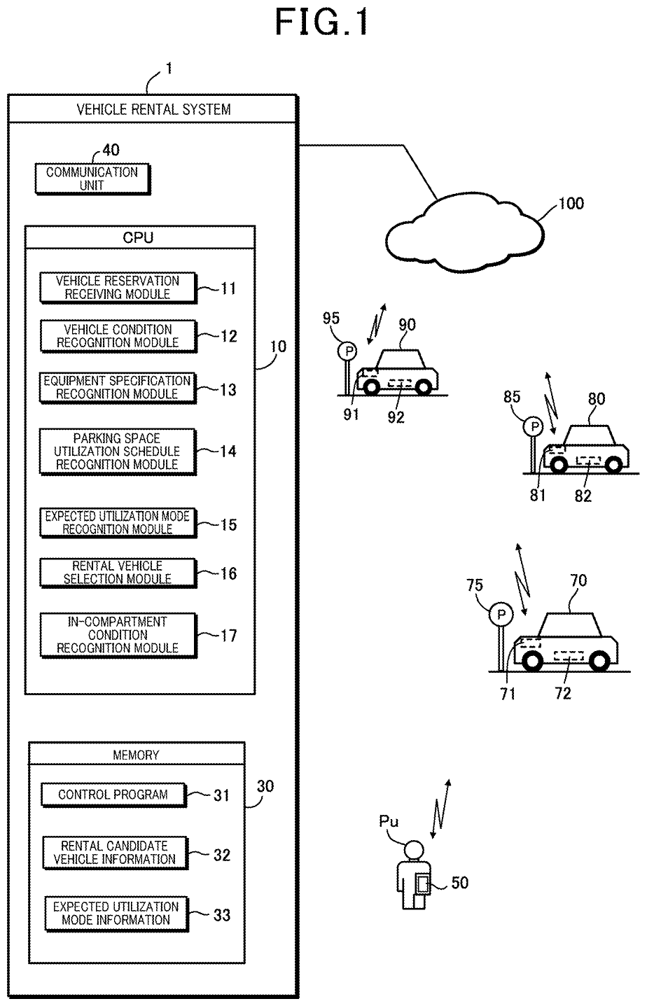

Referring to FIGS. 1 to 3, the configuration of a vehicle rental system 1 according to an embodiment of the present invention will be described. FIG. 1 illustrates the configuration of the vehicle rental system 1 of this embodiment and situations where the vehicle rental system 1 executes a reservation process according to an application for reservation or a reservation request from a user Pu.

FIG. 1 illustrates rental candidate vehicles 70, 80, 90 as rental candidate vehicles controlled by the vehicle rental system 1. The vehicle rental system 1 provides service for renting the rental candidate vehicles 70, 80, 90 by means of car sharing or car rental. In this embodiment, the rental candidate vehicles 70, 80, 90 are electrically driven vehicles using batteries 72, 82, 92, respectively, as their power sources and are controlled using Electronic Control Units (ECUs) 71, 81, 91. The rental candidate vehicles 70, 80, 90 are parked in parking spaces 75, 85, 95, respectively, which constitute waiting places from and to which the rental candidate vehicles 70, 80, 90 are rented and returned.

The vehicle rental system 1 is a computer system made up of a central processing unit (CPU) 10, a memory 30, a communication unit 40, and the like. The communication unit 40 communicates with ECUs 71, 81, 91 that are installed on the rental candidate vehicles 70, 80, 90 and a communication terminal 50 carried by the user Pu. The communication terminal 50 is a portable communication terminal such as a smartphone, a mobile phone, a tablet computer, or the like.

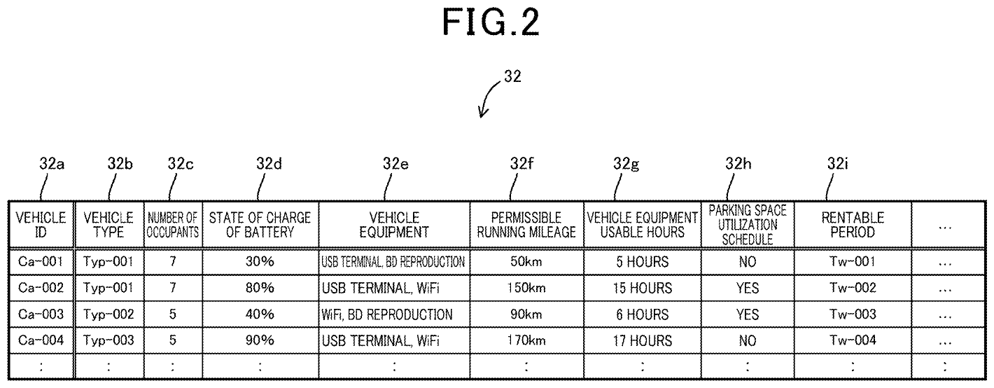

The memory 30 stores a control program 31 of the vehicle rental system 1, rental candidate vehicle information 32, and expected utilization mode information 33. As illustrated in FIG. 2, information is recorded in the rental candidate vehicle information 32 for each of the rental candidate vehicles controlled by the vehicle rental system 1, and the information includes vehicle identifications (IDs) denoted by reference numeral 32a, vehicle types denoted by reference numeral 32b, the numbers of occupants denoted by reference numeral 32c, states of charges of batteries denoted by reference numeral 32d, vehicle equipment denoted by reference numeral 32e, permissible running mileages denoted by reference numeral 32f, vehicle equipment usable hours denoted by reference numeral 32g, parking space utilization schedules denoted by reference numeral 32h, and rentable periods denoted by reference numeral 32i.

The vehicle ID is identification information issued by the vehicle rental system 1 to control each of the rental candidate vehicles. The model types may be types (sedan, hatchback, minivan, and the like) of the rental candidate vehicles or model or vehicle names. The state of charge of the battery is recorded based on measurement data of the state of charge of the battery that is transmitted individually from the rental candidate vehicles. The vehicle equipment is equipment that the user Pu can utilize in the rental candidate vehicles and includes USB terminals that can be used for charging electronic equipment, a WiFi™ communication unit usable in having access to a communication network 100 wirelessly, a reproduction device of a BD (Blu-ray Disc, Blu-ray is a registered trademark), audio equipment, a radio, an air conditioner, and the like.

The permissible running mileage is calculated based on the state of charge of the battery and a consumed power per unit running mileage based on the type of the vehicle. The vehicle equipment usable hour is calculated based on the state of charge of the battery and a consumed power per unit hour of vehicle equipment. The parking space utilization schedule indicates a utilization schedule of the parking space by a returned rental vehicle. In the case where the parking space is scheduled to be used on a certain date, the parking space has to be let free by the certain date. The rentable period indicates a free period when no reservation has been made and hence the user Pu can make a reservation.

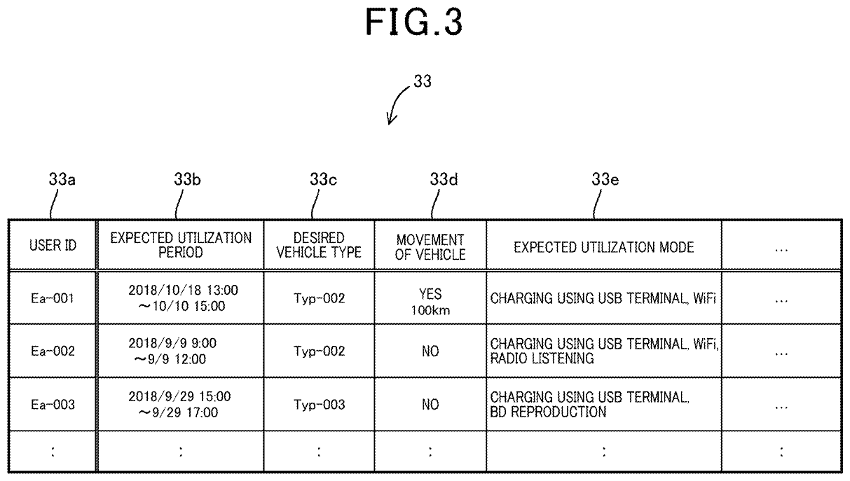

As illustrated in FIG. 3, information is recorded in the expected utilization mode information 33 for each of users who are registered in the vehicle rental system 1, and the information includes user IDs denoted by reference numeral 33a, expected rental vehicle utilization periods (reservation periods) denoted by reference numeral 33b, desired vehicle types denoted by reference numeral 33c, movement of vehicle denoted by reference numeral 33d, and expected utilization modes denoted by reference numeral 33e.

The user ID is identification information issued by the vehicle rental system 1 to control reservations of the rental vehicles by the users. The expected utilization period is a reservation period of the rental vehicle that is requested by the user. The desired vehicle type is the type of the rental vehicle for which the user makes a request for reservation. The movement of the vehicle indicates whether the rental vehicle is to be moved by the user. In the case where the movement of the vehicle is requested, the user is expected to use the rental vehicle for moving or traveling, whereas in the case where the movement of the vehicle is not requested, the user is expected to use the rental vehicle as it is, that is, while it is parked, as a space without moving the rental vehicle. When the rental vehicle is used as a space, various utilization modes can be anticipated, including a working space, a resting space, a music listening space, a video watching space, and the like.

CPU 10 reads and executes the control program 31 and functions as a vehicle reservation receiving module 11, a vehicle condition recognition module 12, an equipment specification recognition module 13, a parking space utilization schedule recognition module 14, an expected utilization mode recognition module 15, a rental vehicle selection module 16, and an in-compartment condition recognition module 17. Hereinafter, a case will be described in which the user Pu makes a reservation for a rental vehicle in situations illustrated in FIG. 1.

Processing executed by the vehicle condition recognition module 12 corresponds to a vehicle condition recognition step of a vehicle rental method of the present invention, and processing executed by the expected utilization mode recognition module 15 corresponds to an expected utilization mode recognition step of the vehicle rental method of the present invention. Processing executed by the rental vehicle selection module 16 corresponds to a rental vehicle selection step of the vehicle rental method of the present invention.

The vehicle reservation receiving module 11 receives a reservation of a rental vehicle by receiving reservation application or request information transmitted from the communication terminal 50 of the user Pu. The vehicle condition recognition module 12 recognizes states of charges of the batteries 72, 82, 92 based on measurement data on states of charges of the batteries 72, 82, 92 that are transmitted from the ECUs 71, 81, 91 of the rental candidate vehicles 70, 80, 90 and records the states of charges of the batteries 72, 82, 92 so transmitted in the rental candidate vehicle information 32.

The equipment specification recognition module 13 recognizes equipment specifications of the rental candidate vehicles 70, 80, 90 based on equipment specification data transmitted from the ECU 71, 81, 91 of the rental candidate vehicles 70, 80, 90 and records them in the rental candidate vehicle information 32. The parking space utilization schedule recognition module 14 recognizes expected utilization schedules of the parking spaces 75, 85, 95 where the rental candidate vehicles 70, 80, 90 are parked waiting to be rented based on return place application or request information transmitted individually from the rental candidate vehicles registered in the vehicle rental system 1 and records them in the rental candidate vehicle information 32.

The expected utilization mode recognition module 15 recognizes an expected utilization mode of the rental vehicle by the user Pu based on a reservation condition by the user Pu that the vehicle reservation receiving module 11 receives and records it in the expected utilization mode information 33. The rental vehicle selection module 16 selects, as a rental vehicle, one of the rental candidate vehicles that can be used according to the expected utilization mode of the user Pu that is recognized by the expected utilization mode recognition module 15 based on results of the recognitions by the vehicle condition recognition module 12, the equipment specification recognition module 13, and the parking space utilization schedule recognition module 14.

The in-compartment condition recognition module 17 receives image of interiors of passenger components that are imaged by cameras provided in the passenger compartments of the rental candidate vehicles 70, 80, 90 and are transmitted from the rental candidate vehicles 70, 80, 90 and recognizes a degree of neatness of the in-compartment conditions of the passenger compartments of the rental candidate vehicles 70, 80, 90. The in-compartment condition recognition module 17 compares images of in-compartment conditions of the passenger compartments that are put in good order (stored in advance in the memory 30) with the images of the current in-compartment conditions of the rental candidate vehicles 70, 80, 90 that the in-compartment condition recognition module 17 receives to evaluate the current neatness levels of in-compartment conditions of the rental candidate vehicles 70, 80, 90. In this case, as the degree of difference in neatness between the compared images increases higher, the neatness levels of the in-compartment conditions of the rental candidate vehicles 70, 80, 90 deteriorate more.

As another configuration, in placed of the cameras provided inside the passenger compartments of the rental candidate vehicles 70, 80, 90, users may capture images of the interiors of the passenger compartments of the rental candidate vehicles 70, 80, 90 using cameras incorporated in their smartphones when they finish utilizing the rental candidate vehicles 70, 80, 90 and transmit the images so captured to the vehicle rental system 1. In this case, the in-compartment condition recognition module 17 compares the images of the in-compartment conditions of the passenger compartments that are put in good order (stored in advance in the memory 30) with the images of the in-compartment conditions of the rental candidate vehicles 70, 80, 90 captured by the users when the users finish utilizing them and transmitted to the vehicle rental system 1 to evaluate the current neatness levels of in-compartment conditions of the rental candidate vehicles 70, 80, 90.

### 2. Rental Vehicle Selection Process

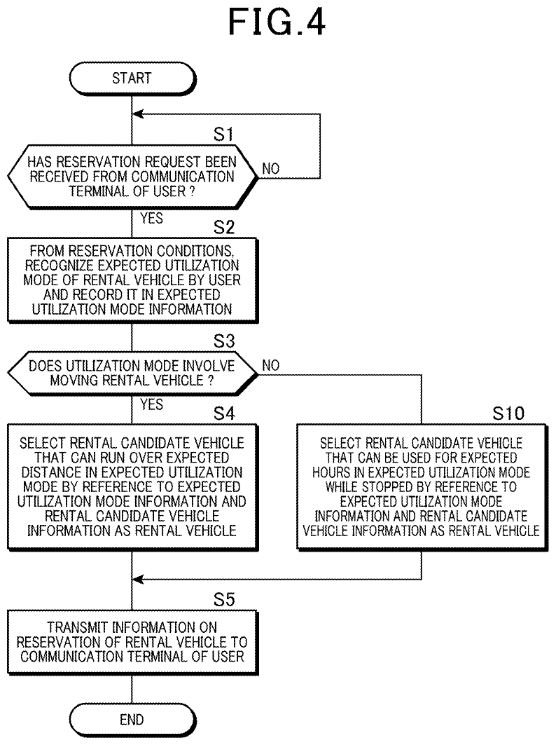

Next, according to a flow chart illustrated in FIG. 4, a rental vehicle selection process executed by the vehicle rental system 1 will be described.

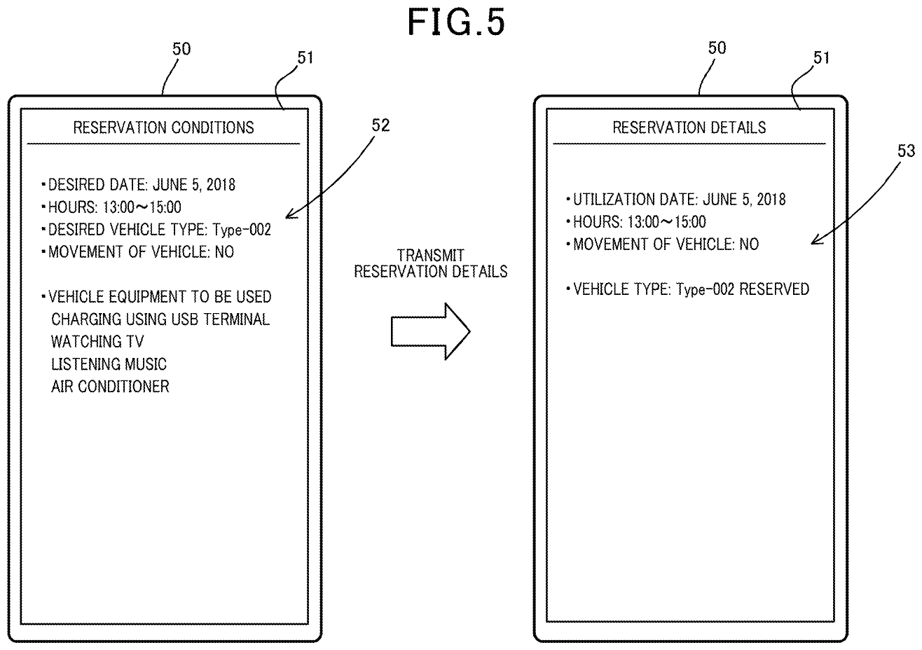

In FIG. 4, in step S1, upon receiving reservation application or request information from the communication terminal 50 of a user Pu, the vehicle reservation receiving module 11 proceeds to a process in step S2. Here, FIG. 5 illustrates a reservation receiving screen 52 displayed on a touch panel 51 of the communication terminal 50 when the user Pu has access to a rental vehicle reservation site provided by the vehicle rental system 1 through the communication terminal 50.

The reservation receiving screen 52 displays, as reservation conditions, desired time and date of reservation, desired vehicle type, whether the user Pu moves the rental vehicle that the user Pu is going to reserve, expected utilization mode of vehicle equipment, and the like. Then, in step S2, the expected utilization mode recognition module 15 recognizes an expected utilization mode of the rental vehicle by the user Pu based on reservation conditions that the user Pu inputs and records it in the expected utilization mode information 33.

In the following step S3, the rental vehicle selection module 16 determines whether the expected utilization mode of the rental vehicle by the user Pu involves moving the rental vehicle. Then, if it determines that the expected utilization mode of the rental vehicle by the user Pu involves moving the rental vehicle, the rental vehicle selection module 16 proceeds to a process in step S4, whereas if it determines that the expected utilization mode of the rental vehicle by the user Pu does not involve moving the rental vehicle (a utilization mode in which the rental vehicle is utilized as it is parked), the rental vehicle selection module 16 proceeds to a process in step S10.

In step S10, the rental vehicle selection module 16 selects one of the rental candidate vehicles that satisfies the following first to third conditions as a rental vehicle by reference to the rental candidate vehicle information 32 and then proceeds to a process in step S5.

First Condition: the rental candidate vehicle includes equipment matching the expected utilization mode of the user Pu;

Second Condition: the state of charge of the battery of the rental candidate vehicle is at such a level that enables the rental candidate vehicle to be utilized within the expected utilization period in the expected utilization mode; and

Third Condition: the rental candidate vehicle does not have to be moved from the parking space where it is parked within the expected utilization period.

Here, the rental vehicle selection module 16 may select the rental vehicle by excluding the rental candidate vehicles in which the neatness level of in-compartment conditions of passenger compartment recognized by the in-compartment condition recognition module 17 does not reach the predetermined good neatness level.

In the example illustrated in FIG. 5, since the expected utilization mode includes charging using a USB terminal, watching television programs, listening to music, and air conditioner, from the first condition, the rental candidate vehicles including equipment that enables these utilization modes to be satisfied are extracted. In addition, from the third condition, the rental candidate vehicles are extracted for preference which are parked waiting to be rented in parking spaces to which other vehicles are not scheduled to be returned within at least the expected utilization period requested under the reservation conditions. This ensures the utilization of the rental vehicle while it is parked in the parking space within the expected utilization period.

On the other hand, in step S4, the rental vehicle selection module 16 selects one of the rental candidate vehicles that satisfies the following fourth to fifth conditions as a rental vehicle by reference to the rental candidate vehicle information 32 and then proceeds to a process in step S5.

Fourth Condition: the rental candidate vehicle includes equipment that matches the expected utilization mode of the user Pu; and

Fifth Condition: the state of charge of the battery of the rental candidate vehicle is at such a level that enables the rental candidate vehicle to cover the expected running mileage.

In step S5, the rental vehicle selection module 16 transmits information on the reservation of the rental vehicle selected in step S4 or S10 to the communication terminal 50 of the user Pu. As illustrated in FIG. 5, the communication terminal 50 displays a reservation completed screen 53 displaying the details of the reservation on the touch panel 51. Then, the user Pu can confirm by watching the reservation completed screen 53 whether the rental vehicle satisfying the requests of the user Pu has been reserved.

### 3. Other Embodiments

In the embodiment described above, while the electrically driven vehicles are described as being the rental candidate vehicles, the present invention can also be applied even when the rental candidate vehicles are vehicles using combustion of fossil fuel as its energy source or electric hybrid vehicles. In this case, the vehicle condition recognition module 12 recognizes, for example, a residual amount of fossil fuel as a condition of the rental candidate vehicle.

In the embodiment described above, while the rental vehicle selection module 16 is described as selecting the rental vehicle based on the future utilization situations of the parking spaces recognized by the parking space utilization schedule recognition module 14, the rental vehicle selection module 16 may select the rental vehicle without taking the utilization schedules of the parking spaces into consideration.

In the embodiment described above, the vehicle rental system 1 is made up of the computer system that communicates with the communication terminal 50 of the user Pu. As another configuration, the whole or part of the configuration of the vehicle rental system 1 may be made up of the communication terminal 50 of the user Pu. When the whole of the configuration of the vehicle rental system 1 is made up of the communication terminal 50 of the user Pu, the communication terminal 50 receives the vehicle conditions, the equipment specifications, and the like from the individual rental candidate vehicles and selects the rental vehicle including the vehicle equipment and the state of charge of the battery that satisfy the expected utilization mode of the user Pu.

In the embodiment described above, the rental candidate vehicle information 32 and the expected utilization mode information 33 are described as being stored in the memory 30 of the vehicle rental system 1. As another configuration, the rental candidate vehicle information 32 and the expected utilization mode information 33 may be stored using a blockchain platform between the vehicle rental service provider who operates the vehicle rental system 1 and users. According to this configuration, in processes in steps S2, S4, S10 in FIG. 4, histories of the expected utilization mode information 33 and the rental candidate vehicle information 32 can simply be referred to by using the structures of the blockchain.

It should be noted that FIG. 1 is a schematic diagram illustrating the functional configuration of the vehicle rental system 1 as being divided based on the main processing contents to facilitate the understanding of the invention of the present patent application, and hence, the configuration of the vehicle rental system 1 may be divided according to another basis. The processing of each constituent element may be executed by one hardware unit or may be executed by a plurality of hardware units. The processing of each constituent element illustrated in FIG. 4 may be executed by one program or may be executed by a plurality of programs.

### Reference Signs List

1 vehicle rental system
10 CPU
11 vehicle reservation receiving module
12 vehicle condition recognition module
13 equipment specification recognition module
14 parking space utilization schedule recognition module
15 expected utilization mode recognition module
16 rental vehicle selection module
17 in-compartment condition recognition module
30 memory
31 control program
32 rental candidate vehicle information
33 expected utilization mode information
50 user communication terminal
70, 80, 90 rental candidate vehicle
71, 81, 91 ECU
72, 82, 92 battery
100 communication network
Pu user

What is claimed is:

1. A vehicle rental system comprising:
a vehicle condition recognition module configured to recognize conditions of a plurality of rental candidate vehicles;
an expected utilization mode recognition module configured to recognize an expected utilization mode which is a utilization mode for a rental vehicle that a user expects; and
a rental vehicle selection module configured to select one of the rental candidate vehicles that can be used according to the expected utilization mode based on the conditions of the plurality of rental candidate vehicles that are recognized by the vehicle condition recognition module as a rental vehicle for the user.

2. The vehicle rental system according to claim 1,
wherein the expected utilization mode comprises a mode in which the rental vehicle is used without being moved.

3. The vehicle rental system according to claim 1, comprising:
an equipment specification recognition module configured to recognize equipment specifications of the plurality of rental candidate vehicles,
wherein the expected utilization mode includes a utilization of equipment of the rental vehicle by the user, and
wherein the rental vehicle selection module selects, as the rental vehicle for the user, one of the rental candidate vehicles that can be used according to the expected utilization mode based on the conditions of the plurality of rental candidate vehicles that are recognized by the vehicle condition recognition module and the equipment specifications of the plurality of rental candidate vehicles that are recognized by the equipment specification recognition module.

4. The vehicle rental system according to claim 1,
wherein the plurality of rental candidate vehicles are electrically driven vehicles,
wherein the vehicle condition recognition module recognizes a state of charge of a battery equipped on each of the plurality of rental candidate vehicles as the conditions of the plurality of rental candidate vehicles, and
wherein the rental vehicle selection module selects, as the rental vehicle for the user, one of the rental candidate vehicles comprising a battery whose state of charge is at a level where the rental candidate vehicle can be used according to the expected utilization mode based on a state of charge of a battery equipped on each of the plurality of rental candidate vehicles that is recognized by the vehicle condition recognition module.

5. The vehicle rental system according to claim 1, comprising:
a parking space utilization schedule recognition module configured to recognize utilization schedules of parking spaces where the plurality of rental candidate vehicles are parked waiting to be rented,
wherein the rental vehicle selection module selects for preference, as the rental vehicle for the user, one of the rental candidate vehicles that does not have to be moved from a parking space where the rental candidate vehicle is parked waiting to be rented based on a result of a recognition by the parking space utilization schedule recognition module.

6. The vehicle rental system according to claim 1, comprising:
an in-compartment condition recognition module configured to recognize an in-compartment condition of the rental candidate vehicle,
wherein the rental vehicle selection module makes selections for the rental vehicle for the user by excluding the rental candidate vehicles whose in-compartment conditions recognized by the in-compartment condition recognition module do not reach a predetermined well-conditioned level.

7. A vehicle rental method comprising:
a vehicle condition recognition step of recognizing conditions of a plurality of rental candidate vehicles;
an expected utilization mode recognition step of recognizing an expected utilization mode which is a utilization mode for a rental vehicle that a user expects; and
a rental vehicle selection step of selecting one of the rental vehicles that is ready for use according to the expected utilization mode based on the conditions of the plurality of rental candidate vehicles that are recognized by the vehicle condition recognition module as a rental vehicle for the user.
